(19) United States
(12) Patent Application Publication
(10) Pub. No.: US 2010/0176142 A1
(43) Pub. Date: Jul. 15, 2010

(54) Plastic Paint Can

(75) Inventors: Terry L. Kline, Wheaton, IL (US); Charles S. Hushka, Tinley Park, IL (US); Jun Y. Choi, Naperville, IL (US); Frank Nania, Naperville, IL (US); Alfonso Arciniegas, Morton Grove, IL (US)

Correspondence Address: COOK ALEX LTD, SUITE 2850, 200 WEST ADAMS STREET, CHICAGO, IL, 60606, US

(73) Assignee: CENTRAL CAN COMPANY, Chicago, IL (US)

(21) Appl. No.: 12/729,012

(22) Filed: Mar. 22, 2010

Related U.S. Application Data
(63) Continuation of application No. 11/119,050, filed on Apr. 29, 2005, now abandoned.

(51) Int. Cl. B65D 41/18; B29C 33/44

(52) U.S. Cl. 220/792; 264/219

(57) ABSTRACT

A paint can has a molded plastic bucket and cover which are releasably engageable with one another at a seal. The bucket has an integrally-formed handle with a cushioned grip formed therein. The handle has an enlarged central portion that facilitates knitting of the molten material fed into the handle mold. The cover has a central panel and a surrounding closure member joined to the panel by a connector. The connector supports the central panel intermediate the a first sealing surface on the closure member. The connector resiliently urges the closure member into sealing engagement with the bucket rim. The sealing surfaces have a polished finish. Grooves in a reinforcing ring on the bucket provide access for removal of the cover.

### BACKGROUND OF THE INVENTION

This invention relates to containers for liquids and is particularly concerned with a container intended for use with paint and similar materials. It will be understood that the invention is directed to the structure of a container, and is not limited to use with any particular contents. As used herein the term paint can will refer to the combination of a bucket or pail and a cover or lid. Obviously the purpose of a paint can is to contain paint in a condition that protects the paint and prevents unintended release or removal of the paint from the bucket, while allowing convenient access to the paint when desired. A paint can requires a rugged, reliable sealing engagement between the top of the bucket and the cover. Simultaneously, access to the can's contents requires the cover to release its engagement with the bucket upon reasonable, directed effort on the part of the user. These somewhat contradictory requirements have more or less been resolved in satisfactory fashion over the years for traditional metal paint cans. Recently, for reasons of cost and convenience, paint can components integrally molded from plastic materials have become competitive with the metal paint can. However, the traditional antagonism between seal integrity and easy access has raised several difficulties in making the transition from metal cans to plastic ones. Among these problems is the formation of a reliable seal between the bucket and the cover that prevents leaks during shipment, storage and in-store processing, i.e., paint mixing associated with tinting.

Paint cans have traditionally been provided with a carrying handle. Plastic paint cans are no exception. Metal cans usually had a handle in the form of a wire bail. The bail was a separate piece that was pivotally attached to the bucket. The ends of the bail were received in receptacles attached to the bucket to form a hinge. While such an arrangement can be duplicated in plastic buckets, it is preferable in plastic buckets not to have the handle formed as a separate part. This is due to the extra manufacturing step of attaching such a handle to the bucket and due to the problems of assuring that a separate handle remains connected to the bucket. Thus, the handle is preferably integrally formed in plastic paint cans. However, this has also proven to have its share of problems in prior molded paint cans. Failure of the handle in normal use has been a recurring issue. Forming a cushioned grip in the bail has also been considered impractical. The present invention resolves these issues by providing an improved molded paint can.

### SUMMARY OF THE INVENTION

The present invention concerns a paint can that can be molded of plastic material. A primary object of the invention is a paint can having a bucket and cover structure that prevents leaks while allowing the cover to be removed with reasonable effort.

Another object of the invention is a paint can cover having a central panel, a connector and a closure member. The closure member has an inside wall with a sealing surface that is urged into contact with the interior of the bucket by the connector.

Still another object of the invention is a paint can cover having a closure member of the type described wherein the connector locates the central panel intermediate the upper and lower boundaries of the closure member's sealing surface.

An additional object is a cover having a central panel bounded by an upturned edge which joins a radial band disposed below the top wall of a closure member.

Yet another object of the invention is a paint can wherein the sealing surfaces between the cover and bucket are formed with a polished finish.

A further object of the invention is a paint can of the type described that allows stacking of multiple cans without loading the central panel member of the cover.

Yet another object of the invention is an all-plastic bucket whose handle has a widened central portion with a coplanar surface that improves the molding characteristics of the bucket.

A still further object of the invention is an all-plastic bucket having a handle that includes a cushioned grip. The cushioned grip comprises a widened central portion having finger-receiving grooves or indentations formed therein.

A further object of the invention is a cover for an all-plastic paint can having a closure member and a central panel joined by a connector having a lead-in leg which extends down and away from the closure member.

Another object is a bucket having a reinforcing ring with grooves formed therein to provide access to the cover.

These and other desired benefits of the invention, including combinations of features thereof, will become apparent from the following description. It will be understood, however, that a device could still appropriate the claimed invention without accomplishing each and every one of these desired benefits, including those gleaned from the following description. The appended claims, not these desired benefits, define the subject matter of the invention.

The paint can has a bucket and cover which are releasably engageable with one another. The cover has a closure member formed by inside, top and outside walls. The inside and outside walls define first and second sealing surfaces with the first sealing surface having a height at least twice that of the second sealing surface. A resilient connector urges the first sealing surface into engagement with the bucket. The connector includes a lead-in leg attached at one end to the closure member and extending down and away from the closure member. A reverse curve attaches the lead-in leg to a standing leg. The standing leg extends to a radial band that is beneath the top wall. The radial band joins an upturned edge that completes the connector. The upturned edge surrounds and is joined to the perimeter of a central panel of the cover. The central panel is located intermediate the boundaries of the first sealing surface. All sealing surfaces have a polished finish. This construction has been found to form a seal that prevent leaks.

The handle of the bucket has a widened central portion and outer portions that together form a coplanar surface that improves the molding characteristics of the bucket. The handle further includes a cushioned grip at the widened central portion with finger-receiving grooves or indentations formed therein. A reinforcing ring near the rim of the bucket may have grooves which provide access by a user's fingers to the edge of the cover for removing the cover.

### BRIEF DESCRIPTION OF THE DRAWINGS

FIG. 1 is an elevation view of the bucket of the present invention.

FIG. 2 is a top plan view of the bucket of FIG. 1.

FIG. 3 is a bottom plan view of the bucket.

FIG. 4 is a section taken along line 4-4 of FIG. 2.

FIG. 5 is an enlargement of the upper left corner of FIG. 4, illustrating the upper portion of the bucket.

FIG. 6 is a section through an edge of a joined bucket and cover, with a portion of the bottom of a second bucket shown stacked on the cover.

FIG. 7 is a view similar to FIG. 6 showing just the cover.

FIG. 8 is a plan view of the cover of the present invention.

FIG. 9 is a section taken along line 9-9 of FIG. 8.

FIG. 10 is a view similar to FIG. 7, illustrating further details of the closure member.

FIG. 11 is a view similar to FIG. 6, showing just the upper end of the bucket, with the lip column shown in dotted lines flexing to alternate positions, the amount of flexure being exaggerated for illustrative purposes.

FIG. 12 is a plan view of a bucket having an alternate embodiment of the reinforcing ring.

FIG. 13 is a section taken along line 13-13 of FIG. 12, with an installed cover also shown.

### DETAILED DESCRIPTION OF THE INVENTION

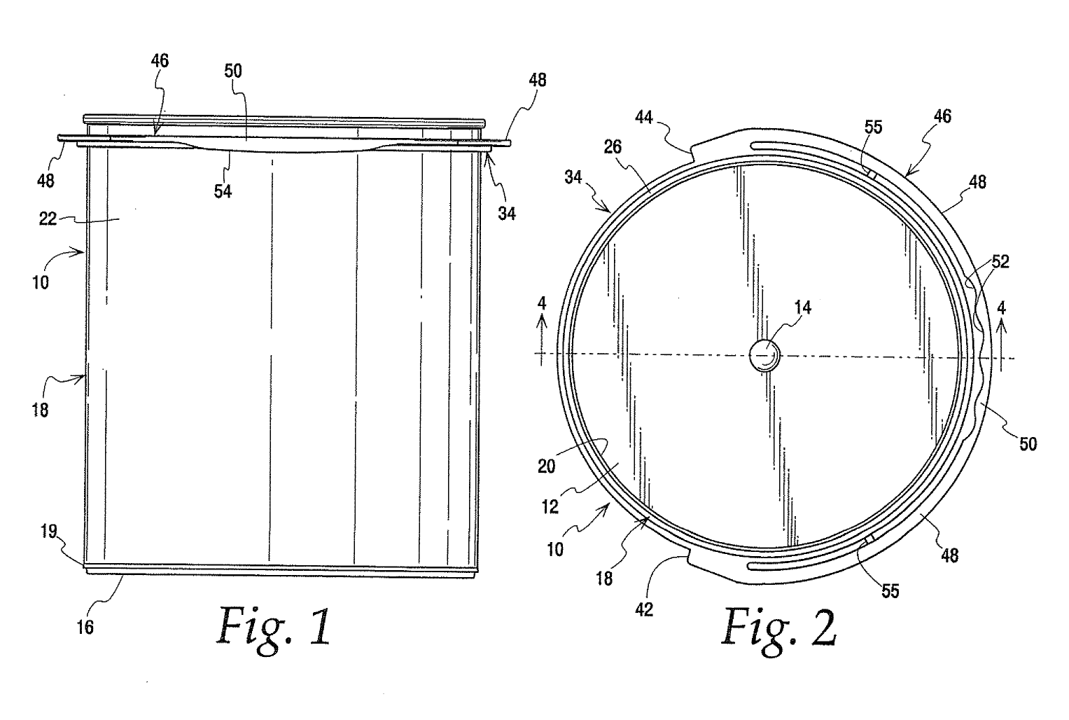

The paint can of the present invention includes a bucket and a cover or lid. The bucket 10 will be described first in conjunction with FIGS. 1-5. The bucket 10 includes a circular floor 12. The center of the floor panel may have a dimple or indentation 14. The dimple provides an advantageous location for the gate in a mold that feeds plastic material for forming the bucket. The molding process will be discussed in greater detail below. On the underside of the floor 12 there is a circular foot 16. The foot is engageable with a cover of a second paint can to facilitate stacking of multiple cans, as will be described in connection with FIG. 6.

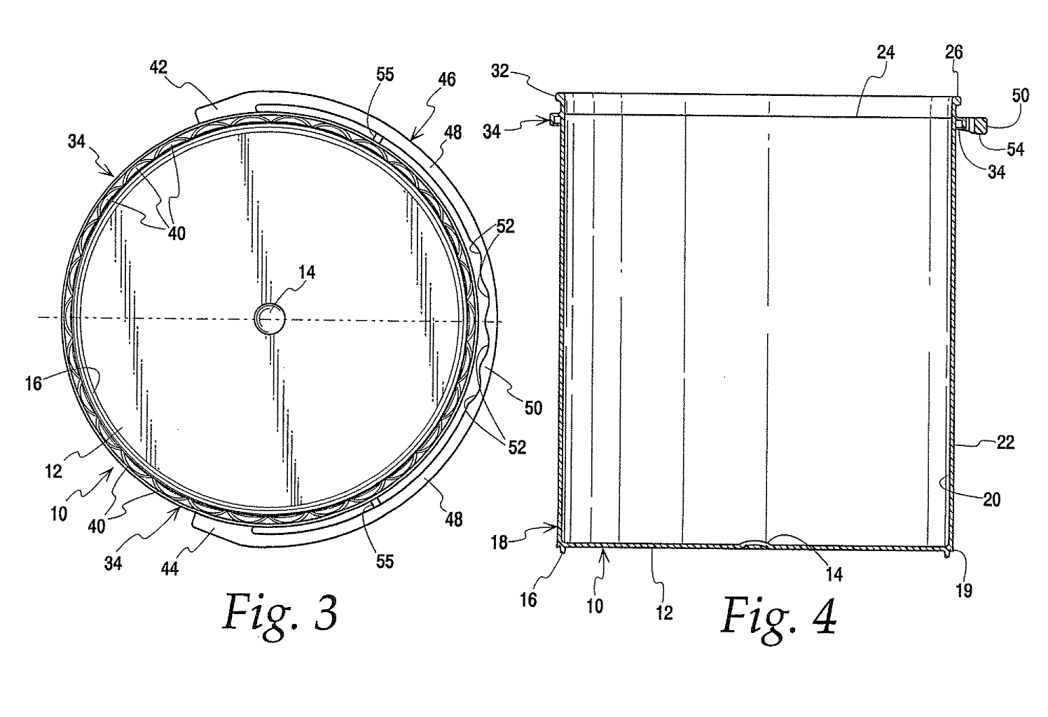

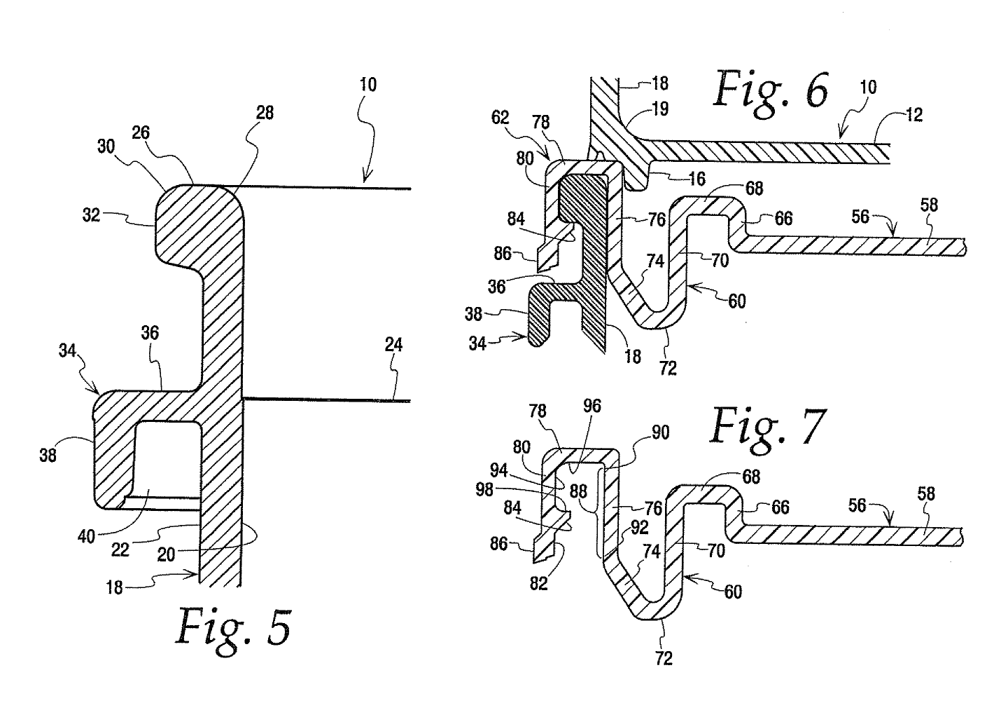

The bucket further includes a cylindrical wall 18 that extends upwardly from the outer edge of the floor 12 to an upper, open end. The wall joins the floor at a junction 19. The wall 18 has an inner face 20 and an outer face 22. At the upper end on the inner face there is a very slight indentation formed by a mold parting line 24 (FIGS. 4 and 5). The upper end portion of the wall terminates at a top land 26. The top land joins the inner and outer faces 20, 22 at corners 28 and 30 (FIG. 5). The corners have a simple radius. Corner 28 defines a circular opening into the interior of the bucket. At the upper end of the wall 18, on the outer face 22, there is a radially extending projection 32. This projection encircles the top of the bucket. It meshes with a catch on the cover to retain the cover on the bucket. The upper end of the wall 18 also includes a reinforcing ring 34 just beneath the projection 32 on the outer surface 22 of the wall 18. The ring is formed by a radial extension 36 and an axial flange 38 attached to the extension. Arcuate ribs or gussets 40 (FIG. 3) are formed underneath the radial extension and inside the axial flange to further stiffen the ring 34.

A pair of handle anchors 42, 44 are attached to the upper end of the bucket wall. In a preferred embodiment the anchors are formed on the outer edge of the reinforcing ring 34, as seen in FIGS. 2 and 3. Alternately, the anchors could be attached directly to the outer surface 22 of the upper end of the wall. The anchors are offset from center to allow the container handle to remain horizontal when filled with product and for labeling. The anchors mount a handle 46. It will be understood that the handle is shown in the as-molded condition where it is in a generally horizontal plane. In use the handle will be pivoted about the anchors to a substantially vertical plane with most of the bucket hanging below the handle. FIG. 2 shows that the handle is a generally semi-circular bail which includes two outer portions 48 and a central portion 50. FIG. 1 shows that central portion 50 has a lower edge 54 that widens the handle in the central portion. Finger indentations or grooves 52 are provided on the underside of the central portion. The central portion provides a cushioned grip that reduces the tendency of the handle to dig into a user's hand or fingers when carrying a full paint can. The finger grooves 52 further enhance the comfort of the handle.

The construction of the handle and in particular the central portion 50 is noteworthy. As best seen in FIG. 1 the central and outer portions 48, 50 have coplanar upper surfaces. However, the lower surface 54 of the central portion extends downwardly below the lower surfaces of the outer portions 48. It will be understood that the references to “upper” and “lower” surfaces of the handle are with respect to the horizontal, as-molded condition of the handle, as shown in FIG. 1, before the handle is pivoted to a vertical plane for use. With the construction shown the cross sectional area of the central portion 50 is greater than that of the outer portions 48. This is important for at least two reasons. First, the lower surface 54 widens the handle which makes it more comfortable in a user's hand, as explained above. It also makes it feasible to form the finger-receiving indentations 52.

The second reason the increased cross sectional area of the central portion 50 is important is for molding purposes. The increased cross sectional area affords sufficient volume in the mold cavity to permit thorough mixing of the molten material during filling of the mold. The handle cavity in the mold is fed from the two anchors 42, 44 so two streams of plastic have to knit together in the center portion 50. This knit zone has been a source of failures in the past. But the increased area of the center portion eliminates any weakness in the knit zone. While conventional practice would dictate not varying the cross section because doing so leads to non-uniform cooling rates, it has been found that the advantages of complete mixing in an enlarged center portion outweigh any difficulties in cooling.

Another feature of the present invention that also aids in solving the knit handle problem is the feed rate of the molten material. It has been found that if all the mold cavities are filled in about one second the knit zone in the handle has adequate strength. The feed rate into the handle can be enhanced by the provision of two frangible tabs 55. These connect the handle outer portions 48 to the reinforcing ring 34. The tabs are small enough to be readily broken when the handle is lifted to a vertical position for use. Tests have shown that with the described construction the knit zone of the handle is not prone to failure. This is because with the fast filling of the handle cavity there is insufficient time for cooling in the handle cavity that in the past has lead to incomplete mixing and weak knitting in the handle.

With the described construction the depending lower surface 54 of the central portion 50 can be formed substantially in one part in the mold, be it a stripper ring or otherwise. In other words, the parting lines for the mold parts that create the central portion 50 will not cross through the widened central portion. This enables extraction of the handle from the mold without distorting the handle. Because the component of the mold which forms the upper surface of the handle does not surround or encompass any portion of the handle, opening movement of that mold component does not tend to pull the handle with it. While the lower surface 54 is shown having the widened portion and the upper surface is coplanar, it will be understood that it could be the reverse. That is, the coplanar side could be on the bottom and the widened portion on top, as the handle is viewed in the position of FIG. 1.

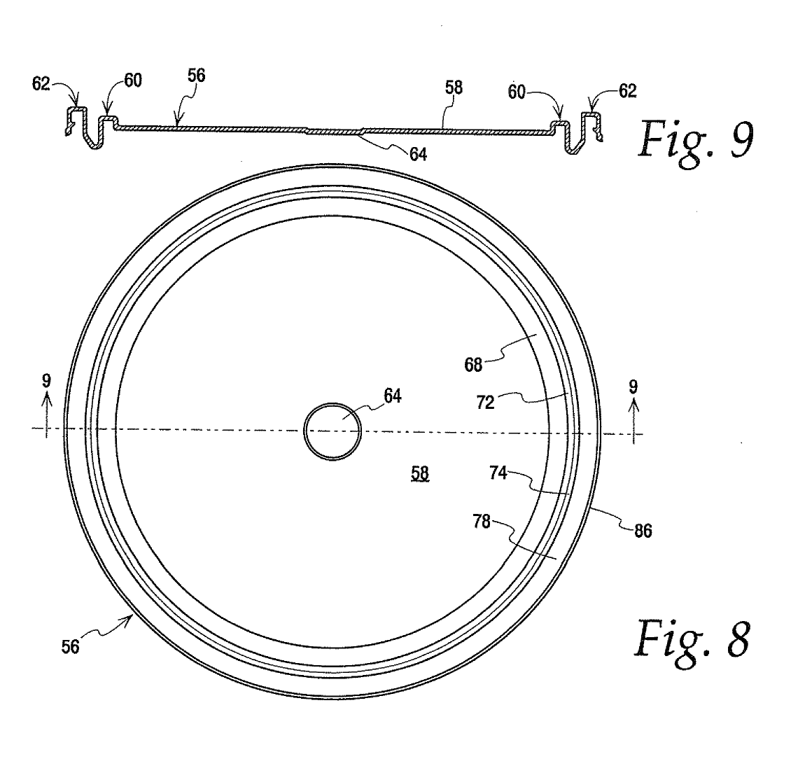

Turning now to the cover, it is shown generally at 56 in FIGS. 6-9. The cover has three main components, a central panel 58, a connector 60, and a closure member 62. The central panel 58 is a circular wall that is flat except for a slight dimple 64 (FIGS. 8 & 9) in the center. The perimeter of the central panel is joined to the connector 60. The connector has a generally S-shape configuration as best seen in FIG. 7. The shape of the connector enables it to maintain the closure member 62 in sealing engagement with the rim of the bucket. Describing the connector 60 from the central panel outwardly, there is a short upturned edge 66 at the perimeter of the panel 58. The upturned edge joins a radial band 68. The radial band connects to the upper end of a standing leg 70. The lower end of the standing leg 70 merges with a reverse curve 72. The reverse curve joins the lower end of a lead-in leg 74. The upper end of the lead-in leg is fixed to the closure member 62.

The closure member 62 has a generally inverted U-shape configuration. It includes an inside wall 76, a top wall 78, and an outside wall 80. Together these three walls define a rim-receiving channel box 82. The outside wall has a catch 84 which protrudes into the channel box 82. The lower edge of the outside wall has a radially protruding bead 86 which strengthens the outside wall to enable it to withstand loads imposed by removing the cover from the bucket.

Each of the closure member walls defines a sealing surface. The inside wall 76 has a first sealing surface shown at 88 in FIG. 7. The first sealing surface terminates at upper and lower boundaries 90 and 92, respectively. Similarly, the outside wall 80 has a second sealing surface shown at 94. It will be noted that the height of the first sealing surface 88 is relatively long, i.e., it is at least twice the height of the second sealing surface 94. Also, the first sealing surface, and its mating bucket surface, are straight or flat. They are uninterrupted by curves or indentations or the like. Third and fourth sealing surfaces 96, 98 are likewise defined on the underside of the top wall 78 and the upper edge of the catch 84. The portions of the bucket rim that are contacted by the sealing surfaces of the cover will be referred to as mating surfaces.

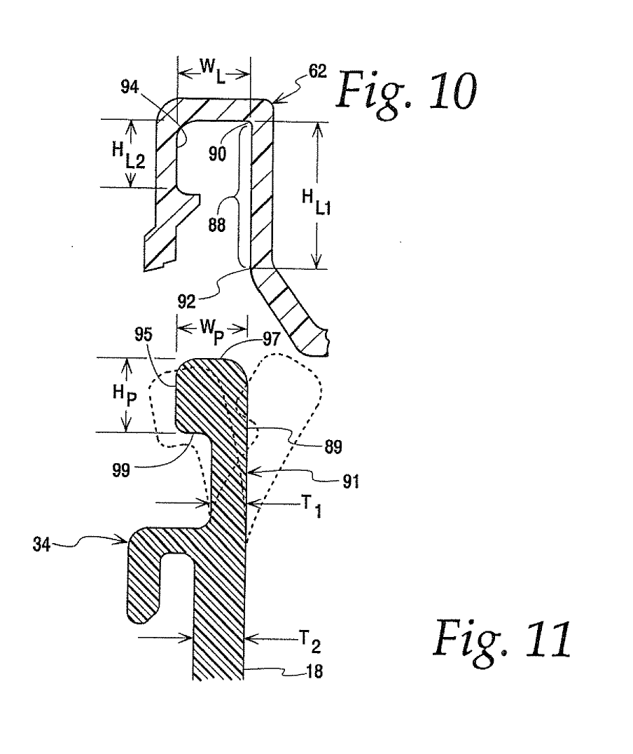

Further details of the closure member 62 and bucket are illustrated in FIGS. 10 and 11. The first sealing surface 88 has a height H_{L1}. The second sealing surface has a height H_{L2}. As just noted, height H_{L1} is as least twice the height H_{L2}. The third sealing surface has a width W_{L}. The bucket wall 18 has a lip column 91 above the reinforcing ring 34. The lip column includes a first mating surface 89 engageable with the first sealing surface 88. Similarly, a second mating surface 95 is engageable with second sealing surface 94. Third and fourth mating surfaces 97, 99 contact the third and fourth sealing surfaces 96, 98 of the cover when the cover is installed on the bucket. Beneath the projection 32 the lip column 91 has a thickness T₁. From the ring 34 down, the bucket wall 18 has a thickness T₂. Also, the bucket's projection or claw 32 has a width W_{P} and a height H_{P}. To enable the paint can to best maintain its cover-to-bucket seal despite tolerances in the cover and bucket, it is preferred that the lip column has the extra flexibility afforded by making T₁ less than T₂. Similarly, the seal is best maintained if channel box width W_{L} is greater than or equal to the claw width W_{P} and the second sealing surface height H_{L2} is greater than or equal to the claw height H_{P}. It has also been found that proper flexure of the closure member outside wall 80 is obtained if the thickness of the top wall 78 is greater than that of the inside and outside walls 76 and 80 by a few thousandths of an inch.

All of the sealing surfaces have what will be called herein a polished finish. A polished finish is a finish produced by a mold cavity defined by a steel wall having an A3 or B1 finish on the steel. The polished finish is also present on the bucket rim surfaces that engage the closure member sealing surfaces. The polished finish enhances the ability of the cover to prevent leaks as there are no irregularities of discontinuities in the engaging surfaces. The A3 or B1 finish is obtained by polishing the mold surface in a direction parallel to a potential leakage path. Thus, on the first and second sealing surfaces 88 and 94, and the bucket surfaces that mate therewith, the polishing of the mold parts (whether a stripper or core), must be done in an axial direction. While circumferential polishing may be more convenient and easier to perform, it will not produce the desired finish on the bucket walls or closure member.

The described shapes of the connector, closure member and bucket rim have been found successful in achieving a reliable cover-to-bucket seal that passes drop testing and will not leak, while at the same time allowing a user to remove the cover with reasonable effort. The S-shaped connector 60 provides a resilient construction that urges the first sealing surface 88 into sealing engagement with the inside wall of the bucket. In particular, the resilience afforded by the standing leg 70 and lead-in leg 74 presses the inside wall 76 against the bucket wall inner face 20 despite tolerances in the bucket and cover dimensions. Such tolerances are absorbed by the flexure available to the lead-in leg and standing leg. This flexure is enhanced by having the lead-in leg 74 extend downwardly and inwardly from the bottom of the closure member 62. The angled lead-in leg spaces the reverse curve 72 inwardly from the inside of the bucket wall. Thus, the reverse curve is not locked against any bucket or cover structure and is free to flex radially as need be at the bottom of the standing leg. The resilience of the standing leg 70 is enhanced by the extra length afforded by the upturned edge 66. Another advantage of the angled lead-in leg is that it aids in centering the cover on the bucket during installation of the cover.

It will be noted that the connector 60 locates the central panel 58 intermediate the upper and lower boundaries 90, 92 of the first sealing surface 88. Further, the middle of the central panel's thickness is beneath the upper edge of the catch 84. The radial band 68 is located below the top wall 78 of the closure member. This prevents it from interfering with the floor of a second container stacked on top of a first container. This is illustrated in FIG. 6. Note the separation between the floor 12 of the upper container and the radial band 68 of the lower container's cover.

Another feature should be pointed out relative to the stacking advantages of the present invention. Since the connector 62 provides a resilient connection between the central panel 68 and the closure member 62, it is important that the floor and junction of the bucket be arranged not to load the central panel of an inferior stacked can. Doing so would detrimentally affect the resilience of the connector. Thus, in the present invention the junction 19 of the bucket floor 12 and wall 18 is arranged to rest directly on the top wall 78 of the closure member 62. Engagement of the foot 16 with the inside diameter of the inside wall 76 assures that the junction 19 will be properly located. Further, the walls of stacked buckets are generally aligned so the weight of the superior can is transferred straight through the top wall 78 directly on to the wall 18 of the inferior can. The inferior can's central panel and connector play no role in transferring the weight. This can be important given the potential in some storage environments for stacking six or more cans on top of one another.

A variety of plastic materials may be suitable for the bucket and cover. A preferred material for the bucket is a polypropylene copolymer. The cover may be made of low linear polyethylene or high density polyethylene. However, it will be understood that substitutions for these materials could be made without departing from the scope of the present invention.

The process for molding the bucket is as follows. A mold is prepared that has cavities for forming the floor, the wall including its upper rim portion, the handle anchors, the handle tabs and the handle. The cavities are in fluid communication so the entire bucket is molded at the same time. Specifically, the handle cavity communicates with the anchor and tab cavities which in turn communicate with the cavity for the upper end portion of the wall, including the reinforcing ring. The wall cavity communicates with the floor cavity. For these purposes the foot may be considered part of the floor. The mold cavities are preferably filled from a single gate, located at the floor dimple 14. Molten plastic material is fed from this gate. The feeding process is controlled so that all mold cavities fill in about one second. This fill rate, coupled with the increased area of the handle central portion, allows knitting of separate flows of molten plastic in the handle cavity without creating weakness at the knit zone.

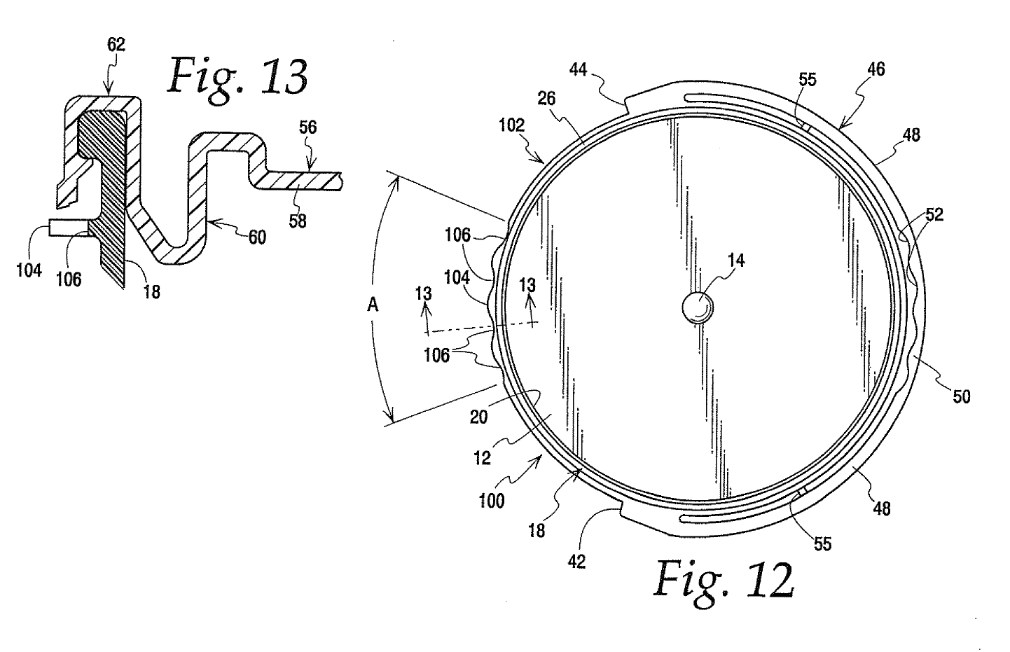

An alternate embodiment of the paint can of the present invention is shown in FIGS. 12 and 13. This embodiment has a bucket 100 with a modified reinforcing ring 102. Except in the area of the arc identified at A in FIG. 12, the reinforcing ring 102 has the same construction as ring 34. In the zone described by arc A the ring 102 has a different construction. Here it is a solid projection 104 from the bucket wall 18 with the outer surface of the projection having a plurality of indentations or grooves 106 formed therein. Four grooves are preferred and the arc A is preferably centered 180° from the center of the handle central portion 50. It will be understood that both the number and location of the grooves could be otherwise. The grooves 104 provide access for a user's fingers to the underside of the closure member's outside wall 80. This enables the user to pry off the cover without the use of a screwdriver or other prying tool. Thus, there is a convenient way to permit a user to open the paint can without the need of an extra tool. At the same time the short hiatus in the reinforcing ring does not significantly adversely affect the hoop strength of the bucket. As an alternate construction, the arcuate portion A could be foamed in a different manner than as a solid protrusion. The grooves 106 could simply be areas where the radial extension 36 and an axial flange 38 are cut away to form the grooves. Or the grooves could be fowled by reducing the radial extent of extension 36.

While the preferred form of the invention has been shown and described herein, it should be realized that there may be many modifications, substitutions and alterations thereto. For example, while the anchors are shown attached to the reinforcing ring, they could be attached directly to the wall of the bucket. That is, the reinforcing ring may be located spaced from the anchors. Or in certain circumstances it may be possible to delete the reinforcing ring altogether. Also, while the bucket wall is shown as completely cylindrical, it need not have this exact shape. It could have a conical upper portion or it could be generally rectangular. Alternately the bucket could include indentations in its side to form hand grips. In addition, the cross sectional shape of the bucket columns could be other than as shown. Rectangular or arcuate sections, either with or without indentations therein, could be used.

1-10. (canceled)

11. A method for making a plastic paint can having a bucket and lid, comprising the steps of:
forming floor and wall cavities in a mold for a bucket, the wall cavity being in fluid communication with the floor cavity, the wall cavity having an inside axially extending polished steel surface and an outside axially extending polished steel surface for forming inside and outside mating surfaces of the bucket, respectively;
forming central panel, closure and connector cavities in a mold for the lid, the connector cavity positioned between and in fluid communication with the closure and central panel cavities, the closure cavity having an inside axially extending polished steel surface and an outside axially extending polished steel surface for forming inside and outside sealing surfaces of the lid, respectively, which engage the inside and outside mating surfaces of the bucket, respectively;
feeding molten plastic material into the bucket mold;
feeding molten plastic material into the lid mold;
solidifying the molten material; and
releasing the finished bucket and lid from the bucket and lid molds.

12. The method of claim 11 wherein all of the [polished] steel surfaces have a A3 or B1 finish.

13. The method of claim 12 wherein all of the axially extending polished steel surfaces are polished in an axial direction.

14. A method for making a mold for a plastic paint can having a bucket and lid, comprising the steps of:
forming floor and wall cavities in a mold for a bucket, the wall cavity being in fluid communication with the floor cavity, the wall cavity having an inside axially extending steel surface and an outside axially extending steel surface for forming inside and outside mating surfaces of the bucket, respectively;
forming central panel, closure and connector cavities in a mold for the lid, the connector cavity positioned between and in fluid communication with the closure and central panel cavities, the closure cavity having an inside axially extending steel surface and an outside axially extending steel surface for forming inside and outside sealing surfaces of the lid, respectively, which engage the inside and outside mating surfaces of the bucket, respectively;
polishing all of the axially extending steel mating and sealing surfaces to a finish of either A3 or B1.

15. A plastic paint can, comprising:
a bucket having a floor and at least one upstanding wall joined to the floor, the wall having inside and outside faces, the wall terminating at a rim which defines an open end of the bucket, the rim including a first mating surface on the inside face, and a second mating surface on the outside face; and
a cover comprising a central panel, a closure member releasably engageable with the rim of the bucket, and a connector joining the closure member to the central panel, the closure member including an inside wall, an outside wall and a top wall joining the inside and outside walls, the inside wall having a first sealing surface engageable with the first mating surface of the rim and the outside wall having a second sealing surface engageable with the second mating surface of the rim, wherein all of said sealing and mating surfaces having a polished finish produced by corresponding mold cavity surfaces having polished steel surfaces.

16. The plastic paint of claim 15 wherein the polished steel surfaces have a A3 or B1 finish.

17. The plastic paint can of claim 16 wherein the A3 or B1 finish is formed by axially only polishing.
